(19) United States
(12) Patent Application Publication
(10) Pub. No.: US 2026/0128552 A1
(43) Pub. Date: May 7, 2026

(54) LOW CONNECTION FORCE CONNECTOR

(71) Applicant: SUMITOMO WIRING SYSTEMS, LTD., Mie (JP)

(72) Inventor: Kentaro HIRAI, Mie (JP)

(21) Appl. No.: 19/365,557

(22) Filed: Oct. 22, 2025

(30) Foreign Application Priority Data
Nov. 1, 2024 (JP) 2024-193068

(51) Int. Cl. H01R 13/629; H01R 13/502

(52) U.S. Cl. CPC H01R 13/62977; H01R 13/502

(57) ABSTRACT

A low connection force connector includes a first housing, a second housing and a slide lever assembled with the second housing. The slide lever includes a cam groove engageable with a first cam pin provided in a receptacle of the first housing and a slide guiding portion for receiving a second cam pin of the second housing. The slide guiding portion extends in an intersecting direction intersecting a connection direction. Connection is advanced by a cam action according to an operation of sliding the slide lever so that the second cam pin moves in the slide guiding portion with the first cam pin introduced in the cam groove, and the both housings are connected according to a rotating operation of rotating the slide lever about the first cam pin.

### CROSS-REFERENCE TO RELATED APPLICATIONS

This application is based on and claims priority from Japanese Patent Application No. 2024-193068, filed on Nov. 1, 2024, with the Japan Patent Office, the disclosure of which is incorporated herein in its entirety by reference.

### TECHNICAL FIELD

The present invention relates to a low connection force connector.

### BACKGROUND

Conventionally, various connectors capable of reducing a load (connection force) required for connector connection have been proposed. For example, Japanese Patent Laid-open Publication No. 2009-087852 describes a lever-type connector in which a lever including a cam groove is mounted on one housing, a cam shaft is provided on the other housing, and the both housings are connected by a cam action by rotating the lever after the both housings are brought closer and the cam shaft is inserted into the cam groove.

Further, Japanese Patent Laid-open Publication No. 2015-090797 describes a slide-type connector in which a slider including a cam groove is mounted in one housing, a connection pin is provided on the other housing, and the both housings are connected by a cam action of pulling the connection pin into the cam grove by pushing the slider in a sliding direction with the connector housings butted against each other.

Furthermore, Japanese Patent Laid-open Publication No. H11-329583 describes a connector configured by assembling both a lever and a slider configured separately with one connector housing.

### SUMMARY

The lever-type connector described above has a relatively large effect of reducing a load (connection force) required for a connecting operation, but a wide space for rotating the lever is necessary on a connector back surface side. Thus, this connector may not be applied to a harness or an ECU to be installed in a narrow location. On the other hand, the slider-type connector does not require any space for operation on a connector back surface side, but an effect of reducing a load required for a connecting operation is relatively small. If the connector has many poles, it may not be possible to reduce the load to a required specified value. Further, the connector assembled with the lever and the slider configured separately includes many components and has a problem that the configuration and an assembly work are cumbersome.

The present disclosure is directed to a low connection force connector with a first housing including a receptacle, a second housing to be fit into the receptacle, and a slide lever assembled with the second housing slidably and rotatably, the slide lever including a cam groove engageable with a first cam pin provided in the receptacle and a slide guiding portion for slidably receiving a second cam pin provided on the second housing, the slide lever being displaceable with respect to the second housing between an initial position located when connection of the both housings is started, a connection completion position located when the connection of the both housings is completed and a slide position located between the initial position and the connection completion position, the slide guiding portion extending in an intersecting direction intersecting a connection direction of the both housings with the slide lever set at the initial position, the connection of the both housings being advanced by a cam action between the cam groove and the first cam pin according to a sliding operation of sliding the slide lever with respect to the second housing so that the second cam pin is moved in the intersecting direction by the slide guiding portion with the first cam pin introduced in the cam groove of the slide lever at the initial position in a connection initial stage of the both housings, and the second cam pin being pressed in the connection direction by the slide guiding portion to connect the both housings according to a rotating operation of rotating the slide lever set at the slide position by the sliding operation to the connection completion position about the first cam pin disposed in the cam groove.

According to the low connection force connector of the present disclosure, a space for a connecting operation can be reduced more than before and a load (connection force) required for the connecting operation can be sufficiently reduced by a simple configuration.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a partial exploded perspective view of a low connection force connector of one embodiment.

FIG. 2 is a section of the low connection force connector before connection (in a state where a slide lever is at an initial position).

FIG. 3 is a section of the low connection force connector in a state where first cam pins are located at pin entrance openings of cam grooves.

FIG. 4 is a section of the low connection force connector in a state where the first cam pins are located in first parts of the cam grooves.

FIG. 5 is a section of the low connection force connector while the first cam pins are being inserted into second parts of the cam grooves and second cam pins are sliding in slide guiding portions.

FIG. 6 is a section of the low connection force connector in a state where the first cam pins are located in third parts of the cam grooves and the second cam pins have slid in the slide guiding portions (in a state where the slide lever is at a slide position).

FIG. 7 is a section of the low connection force connector while the slide lever is being rotated about the first cam pins.

FIG. 8 is a section of the low connection force connector in a state where the slide lever is rotated about the first cam pins (in a state where the slide lever is at a connection completion position).

FIG. 9 is a graph showing a relationship of a stroke of the slide lever and a change of a connection force.

FIG. 10 is a section of a low connection force connector of another embodiment in a state where a slide lever is at a slide position.

FIG. 11 is a section of a low connection force connector of another embodiment in a state where a slide lever is at a slide position.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

(1) The low connection force connector of the present disclosure is provided with a first housing including a receptacle, a second housing to be fit into the receptacle, and a slide lever assembled with the second housing slidably and rotatably, the slide lever including a cam groove engageable with a first cam pin provided in the receptacle and a slide guiding portion for slidably receiving a second cam pin provided on the second housing, the slide lever being displaceable with respect to the second housing between an initial position located when connection of the both housings is started, a connection completion position located when the connection of the both housings is completed and a slide position located between the initial position and the connection completion position, the slide guiding portion extending in an intersecting direction intersecting a connection direction of the both housings with the slide lever set at the initial position, the connection of the both housings being advanced by a cam action between the cam groove and the first cam pin according to a sliding operation of sliding the slide lever with respect to the second housing so that the second cam pin is moved in the intersecting direction by the slide guiding portion with the first cam pin introduced in the cam groove of the slide lever at the initial position in a connection initial stage of the both housings, and the second cam pin being pressed in the connection direction by the slide guiding portion to connect the both housings according to a rotating operation of rotating the slide lever set at the slide position by the sliding operation to the connection completion position about the first cam pin disposed in the cam groove.

According to the above configuration, in the connection initial stage where a load required to connect the both housings can be relatively small, the connection of the both housings can be advanced by the cam action by the sliding operation of the slide lever. Further, in the connection final stage where a relatively large load is necessary to set the both housings at the connection completion position, the connection of the both housings can be completed, utilizing the principle of leverage, by the rotating operation of the rotating the slide lever. By performing an operation of connecting the both housings by a combination of the sliding operation and the rotating operation in this way, an angle of rotation of the slide lever can be made smaller than in the case where the sliding operation is not performed. As a result, a load required for the connecting operation can be sufficiently reduced while a space for the connecting operation on a back surface side of the second housing is reduced more than before. Moreover, since such operations in two stages can be performed by one slide lever, a simple configuration can be realized without increasing the number of components.

(2) The slide lever may be set not to protrude in the intersecting direction from the first housing in a state disposed at the connection completion position.

If the slide lever protrudes from the first housing in the intersecting direction when the connection is completed, the slide lever is easily caught by another component or the like. If a load is applied to the slide lever to rotate the slide lever in a direction opposite to the connection direction, a connected state may be released. According to the above configuration, since the slide lever is hardly caught by another component or the like in the connected state, it can be suppressed that the connected state of the both housings is unintentionally released. Further, in the connected state, the housings can be made compact.

(3) The slide guiding portion may be in the form of a long hole extending in the intersecting direction. According to this configuration, when being slid, the second cam pin is hardly detached from the slide guiding portion. That is, the second cam pin can be stably slid with respect to the slide guiding portion (second housing) and, consequently, the both housings can be smoothly connected.

(4) The slide guiding portion may extend in an orthogonal direction orthogonal to the connection direction of the both housings with the slide lever set at the initial position and extend in a direction oblique to the orthogonal direction with the first cam pin side disposed on an opposite side in the connection direction with the slide lever set at the connection completion position.

(5) The slide lever may include a plate-like arm portion having the cam groove and the slide guiding portion and a locking portion projecting in an extension direction of the slide guiding portion may be provided on an outer periphery of the arm portion, the receptacle may be provided with a locked portion lockable to the locking portion as the slide lever is slid from the initial position to the slide position, and the locking portion may press the locked portion according to the rotating operation of the slide lever, whereby the connection of the both housings progresses.

According to the above configuration, the both housings can be more easily connected, utilizing the pressing of the locking portion with respect to the locked portion according to the rotating operation of the slide lever.

### Details of Embodiment of Present Disclosure

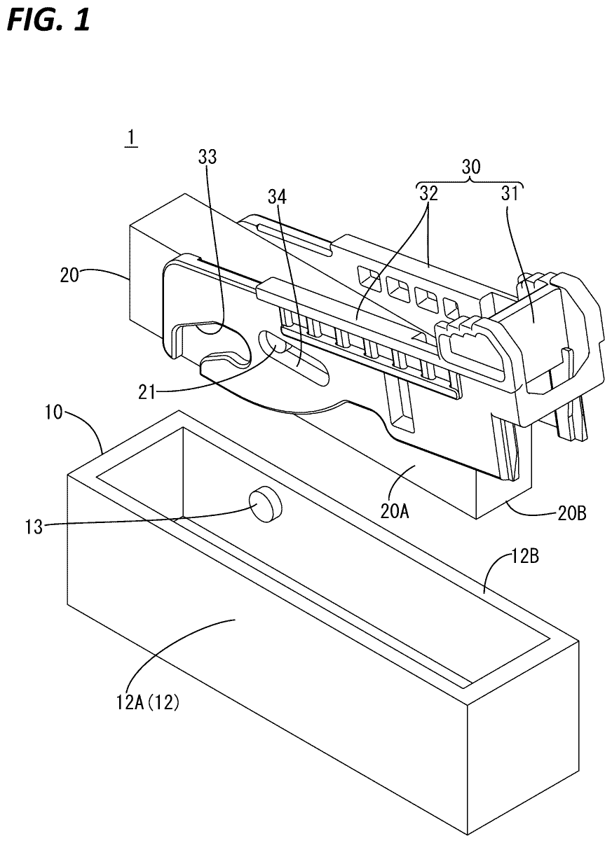

A specific example of a low connection force connector of the present disclosure is described below with reference to FIGS. 1 to 9. Note that the present disclosure is not limited to these illustrations, but is represented by claims and intended to include all changes in the scope of claims and in the meaning and scope of equivalents.

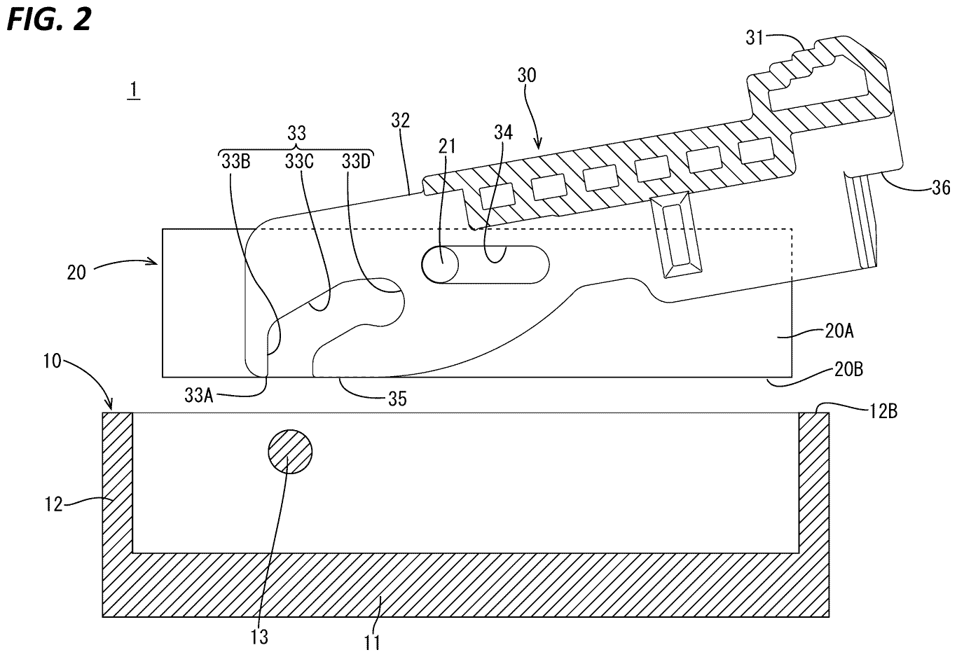

A low connection force connector 1 of this embodiment is provided with a first housing 10 and a second housing 20 connectable to each other and the both housings can be connected/separated to/from each other by operating a slide lever 30 mounted on the second housing 20. Based on a connection direction of the first and second housings 10, 20, a connection surface side is referred to as a front side and a direction intersecting the connection direction is referred to as a side direction below. Further, a vertical direction and a lateral direction are described based on FIG. 2, but upper, lower, left and right sides are not limited to those of this embodiment and can be changed as appropriate. Further, for the sake of convenience, male terminals, female terminals and wires are not shown.

### [First Housing 10]

The first housing 10 is made of synthetic resin and, as shown in FIG. 1, in the form of a rectangular tube elongated in a horizontal direction as a whole. Specifically, the first housing 10 is provided with a male terminal holding portion 11 for holding the male terminals (not shown) and a receptacle 12 in the form of a rectangular tube protruding and open forward from the periphery of the male terminal holding portion 11 (see FIG. 2). A plurality of the male terminals are held in the male terminal holding portion 11 (not shown), and a tab of each male terminal projects into the receptacle 12.

The first housing 10 is provided with a pair of first cam pins 13. The first cam pins 13 have a cylindrical shape and respectively project inwardly of the receptacle 12 at positions near a left side in the lateral direction, out of longer side walls 12A of the receptacle 12 (first housing 10) facing each other.

### [Second Housing 20]

The second housing 20 is made of synthetic resin and in the form of a substantially rectangular block one size smaller than inner dimensions of the first housing 10 to be fittable into the aforementioned first housing 10 (receptacle 12). The second housing 20 is provided with a plurality of cavities penetrating in a front-rear direction, and the female terminal and an end part of the wire connected to the female terminal are accommodated in each cavity (not shown). The second housing 20 is provided with a pair of second cam pins 21. The second cam pins 21 have a cylindrical shape and respectively project outward at positions slightly closer to a left side than a central part in the lateral direction, out of longer side surfaces 20A of the second housing 20 facing each other. The slide lever 30 to be described later is mounted on these second cam pins 21.

### [Slide Lever 30]

The slide lever 30 is made of synthetic resin and substantially gate-shaped as shown in FIG. 1. The slide lever 30 is provided with an operating portion 31 and a pair of arm portions 32 extending from both ends of the operating portion 31 to face each other.

Each of the pair of arm portions 32 is in the form of a thick plate. Each arm portion 32 includes a cam groove 33 for receiving the first cam pin 13 of the first housing 10 described above and a slide hole (an example of a slide guiding portion) 34 for receiving the second cam pin 21 of the second housing 20 described above. The cam grooves 33 are provided by recessing the outer surfaces (surfaces opposite to facing surfaces of the pair of arm portions 32). The slide hole 34 is a long hole penetrating through plate surfaces of the arm portion 32.

The slide lever 30 is mounted to straddle the second housing 20. Specifically, the slide lever 30 is so disposed along the long side surfaces 20A of the second housing 20 that the pair of arm portions 32 sandwich the second housing 20, and is mounted slidably and rotatably with respect to the second housing 20 by fitting the second cam pins 21 into the slide holes 34.

Note that, for the sake of convenience, the following description is based on a state where the slide lever 30 is at an initial position located when the both housings 10, 20 are connected with respect to the second housing 20 (state of FIG. 2). At the initial position, the slide lever 30 is inclined toward a right upper side of FIG. 2 with respect to the second housing 20 as a whole with the operating portion 31 disposed on the right upper side. In this embodiment, the slide lever 30 is inclined toward the right upper side by about 20°.

The aforementioned cam groove 33 includes a pin entrance opening 33A for allowing the entrance of the first cam pin 13 at a position near the left side of a lower edge part of the arm portion 32, and extends to a back side (an upper side of FIG. 2, a rear side in a connection direction) from this pin entrance opening 33A. More particularly, the cam groove 33 includes a first part 33B extending upward from the pin entrance opening 33A, a second part 33C extending obliquely to the right upper side from the back of the first part 33B and a third part 33D extending substantially in a horizontal direction from the back of the second part 33C. The cam groove 33 is disposed on a left end side of the arm portion 32 as a whole.

The slide hole 34 extends rightward in a horizontal direction (direction orthogonal to the connection direction of the both housings 10, 20) from an oblique right upper side of the third part 33D of the cam groove 33 with the slide lever 30 set at the initial position. The slide hole 34 is formed at a position where the second cam pin 21 is disposed on a left end in the slide hole 34 with the slide lever 30 set at the initial position. Further, the slide hole 34 is disposed slightly to the left of a central part in the lateral direction of the arm portion 32 as a whole.

The arm portion 32 includes a part 35 extending straight to overlap a front end 20B (lower end of FIG. 2) of the second housing 20 on a left end side of a lower edge part thereof with the slide lever 30 set at the initial position. In other words, the slide lever 30 can be disposed at the initial position with respect to the second housing 20 by disposing the second cam pins 21 in the left ends of the slide holes 34 and causing the parts 35 extending straight on the left ends of the lower edge parts of the arm portions 32 to overlap the front end 20B of the second housing 20. The part 35 extending straight and disposed on the left end of the lower edge part of the arm portion 32 is referred to as an initial posture guiding portion 35 below. The pin entrance opening 33A of the aforementioned cam groove 33 is formed in this initial posture guiding portion 35.

Further, with the slide lever 30 set at the initial position, a right end part (end part on the side of the operating portion 31) of the slide lever 30 largely protrudes from the right end of the second housing 20. Note that a right lower corner part of the arm portion 32 is cut into an L shape, and a protruding part on a right upper side is referred to as a protruding portion 36 below.

The low connection force connector 1 of this embodiment is configured as described above. Next, a connecting operation of the first and second housings 10, 20 is described.

### [Connection of First Housing 10 and Second Housing 20]

In connecting the both housings 10, 20, the slide lever 30 is first arranged at the initial position with respect to the second housing 20 as shown in FIG. 2. Specifically, the slide lever 30 is so disposed with respect to the second housing 20 that the second cam pins 21 are located on the left ends of the slide holes 34 and the initial posture guiding portions 35 overlap the front end 20B of the second housing 20.

As just described, with the slide lever 30 set at the initial position, the pin entrance opening 33A of the cam groove 33 is open to a front side of the second housing 20 (lower side of FIG. 2). Further, the left end of the arm portion 32 is disposed at a position slightly separated rightward from the left end of the second housing 20. Further, the right end of the arm portion 32 largely protrudes rightward from the right end of the second housing 20. The slide lever 30 is inclined toward the right upper side as a whole.

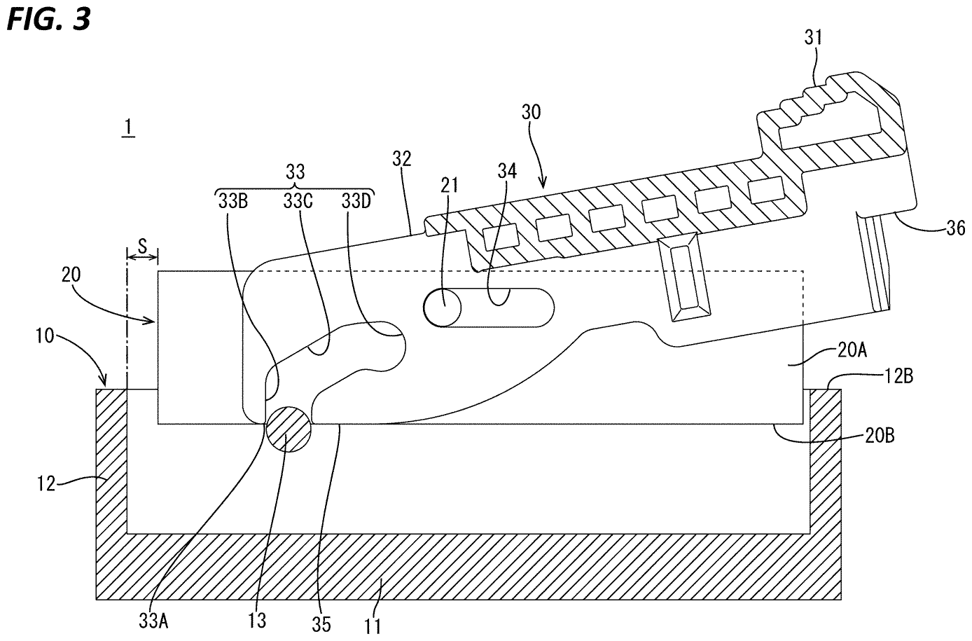

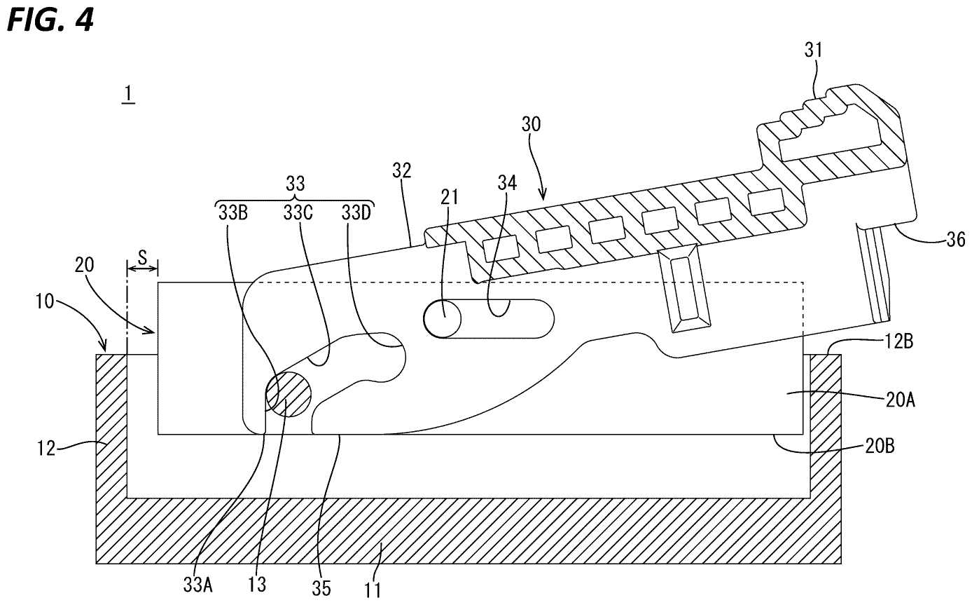

In this state, the second housing 20 is brought closer to the first housing 10 and shallowly fit into the receptacle 12 (see FIGS. 3 and 4). At this time, the second housing 20 is so positioned with respect to the first housing 10 that the first cam pins 13 are inserted into the pin entrance openings 33A of the slide lever 30 set at the initial position. Note that, at the time of this positioning, the positions of the first cam pins 13 are so set in advance that the right end of the second housing 20 is disposed on the right end in the receptacle 12, and a gap S is formed between the first housing 10 and the second housing 20 on the left end in the receptacle 12. The first cam pins 13 having entered the cam grooves 33 through the pin entrance openings 33A move to the upper ends of the first parts 33B (see FIG. 4).

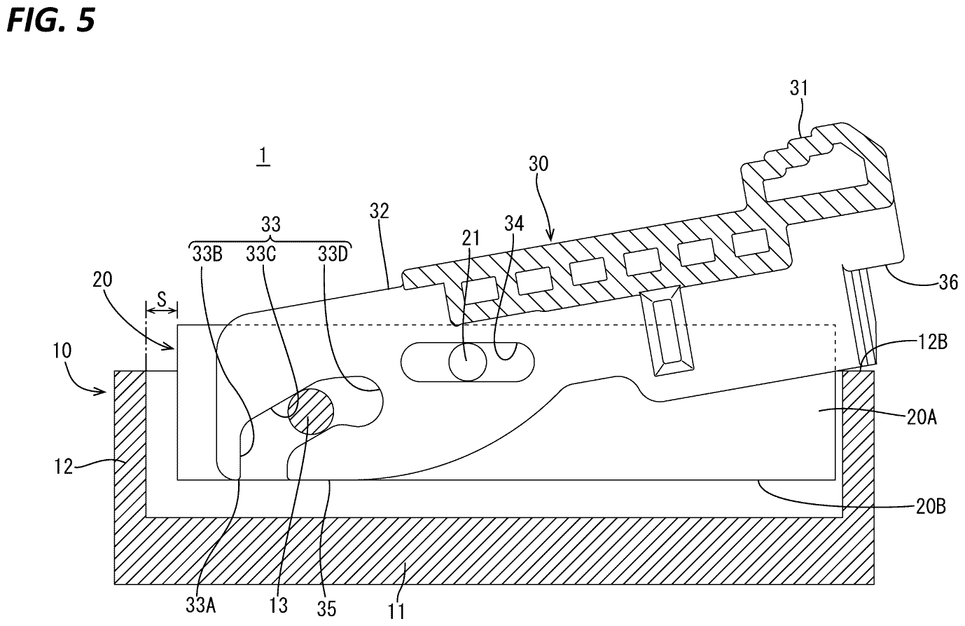

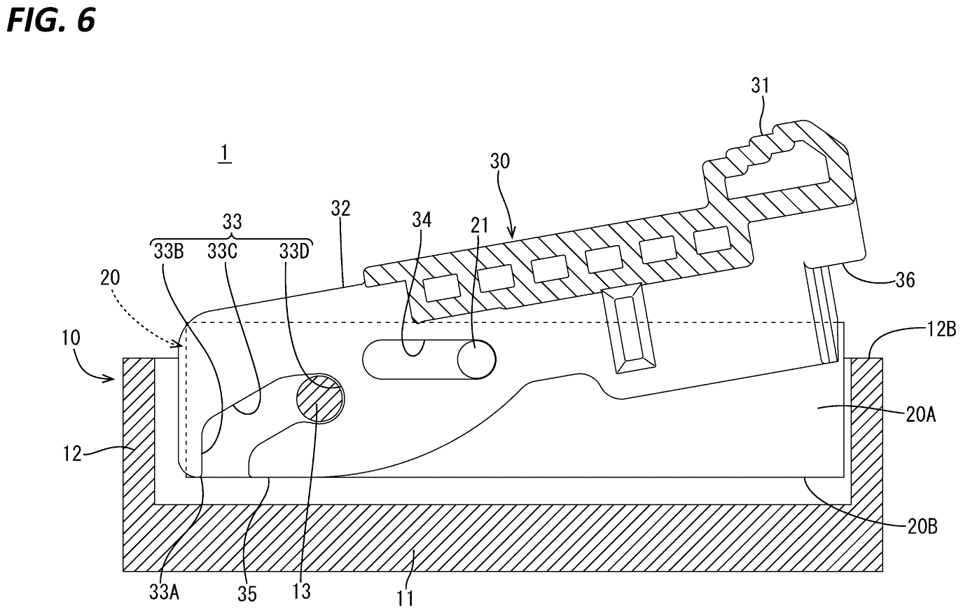

Subsequently, the slide lever 30 is pressed leftward. In this way, the second cam pins 21 disposed on the left ends of the slide holes 34 relatively slide rightward in the slide holes 34 as shown in FIGS. 5 and 6. Further, according to these sliding movements, the first cam pins 13 disposed on the upper ends of the first parts 33B of the cam grooves 33 are inserted to the backs (third parts 33D) while passing through the second parts 33C and the second housing 20 is pulled toward the first housing 10 (downward) by the cam action of the first cam pins 13 and the cam grooves 33 at this time. That is, the connection of the first and second housings 10, 20 progresses.

Note that, while the slide lever 30 is sliding in this way, the right end of the slide lever 30 protrudes rightward from the right side of the receptacle, i.e. from a connection region of the first housing 10. Thus, the rotation of the slide lever 30 to the right lower side is restricted. Further, the slide lever 30 is supported at two points of the first cam pins 13 and the second cam pins 21 with respect to the both housings 10, 20, and the slide lever 30 inclined with respect to the second housing 20 is hardly easily displaced from the state at the initial position. Thus, the second cam pins 21 (second housing 20) can be smoothly slid in the horizontal direction (see FIG. 5).

Further, if the sliding movement of the slide lever 30 is completed and the slide lever 30 reaches a slide position (state of FIG. 6), a right lower part of the slide lever 30 is disposed inside the receptacle 12, i.e. inside the connection region of the first housing 10. In this way, the rotation restriction of the slide lever 30 is released.

Note that, with the slide lever 30 set at the slide position (see FIG. 6), the first cam pins 13 are disposed in the third parts 33D of the cam grooves 33. Further, the second cam pins 21 are disposed on the right ends of the slide holes 34. Further, the left end of the slide lever 30 slightly projects from the left end of the second housing 20 (projects into the gap S), and the right lower part of the slide lever 30 is disposed inside the connection region of the first housing 10 as described above. That is, the slide lever 30 is set in a rotatable state.

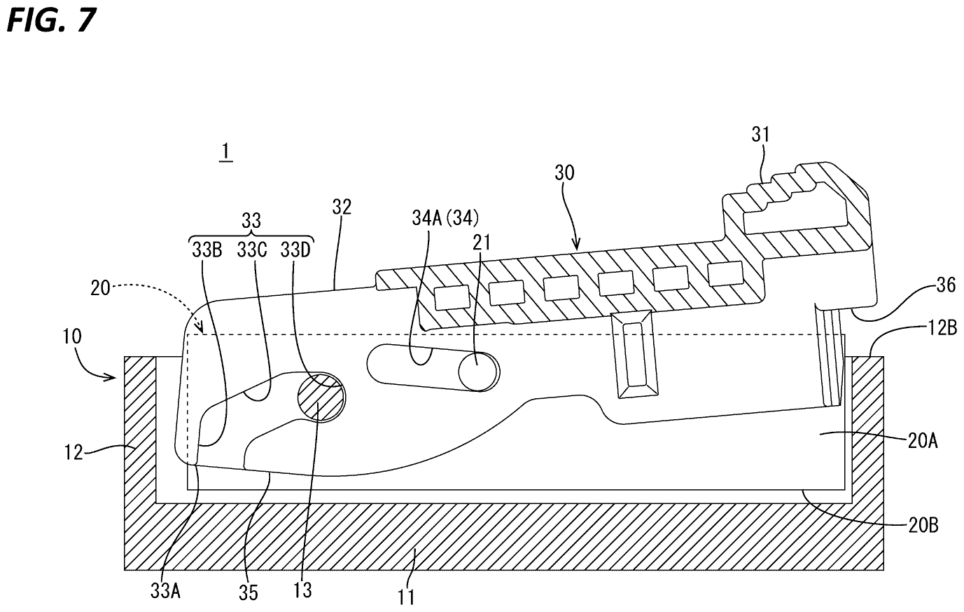

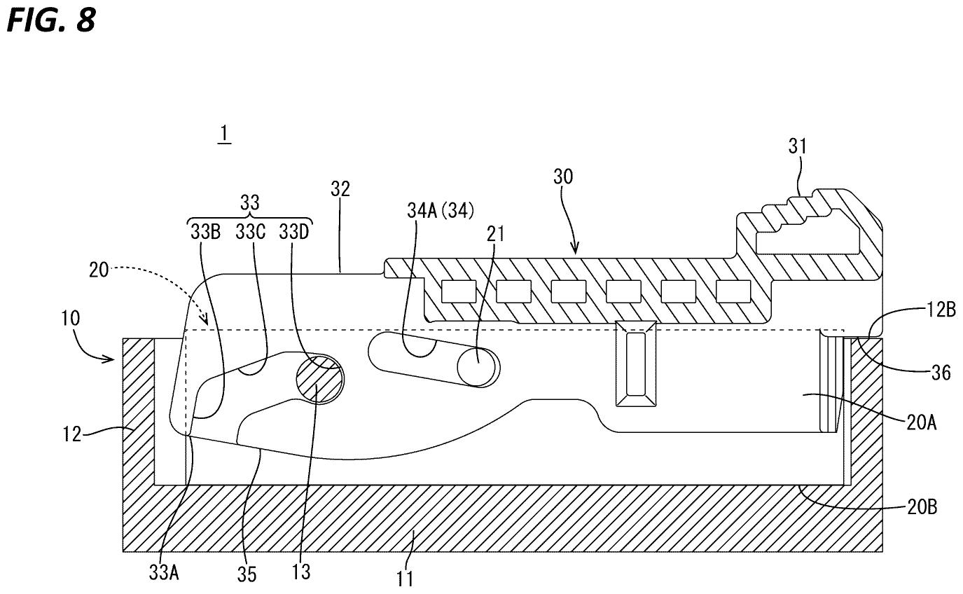

Finally, the operating portion 31 of the slide lever 30 disposed at the slide position is pressed downward. In this way, as shown in FIGS. 7 and 8, the slide lever 30 rotates about the first cam pins 13. Further, as upper edge parts (examples of the slide guiding portion) 34A of the slide holes 34 move downward, the second cam pins 21 are pressed downward, with the result that the second housing 20 approaches the first housing 10 to set the first and second housings 10, 20 in a properly connected state. Note that, on the upper edge part 34A of the slide hole 34, a moving distance is longer toward the right side distant from a center of rotation (first cam pin 13) and the second cam pin 21 disposed on the right end of the slide hole 34 can be largely moved with a relatively small force.

As just described, with the slide lever 30 set at the connection completion position (state of FIG. 8), the slide holes 34 are inclined to the right lower side by an inclination change of the slide lever 30 from the slide position and the second cam pins 21 are disposed slightly to the left of the right ends of the slide holes 34. Further, the left lower end of the slide lever 30 further projects from the left end of the second housing 20 (projects into the gap S).

Further, with the slide lever 30 set at the connection completion position (state of FIG. 8), the lower surfaces of the protruding portions 36 of the slide lever 30 are in contact with a front end 12B of the receptacle 12 (first housing 10) and the right end of the slide lever 30 is disposed to be flush with the right end of the receptacle 12 (disposed not to protrude from the outer surface of the receptacle 12). By setting such a state, it can be suppressed that the slide lever 30 is unintentionally rotated in a connection releasing direction (upward) by the slide lever 30 protruding from the receptacle 12 being caught by another member or an external matter entering between the slide lever 30 and the front end 12B of the receptacle 12.

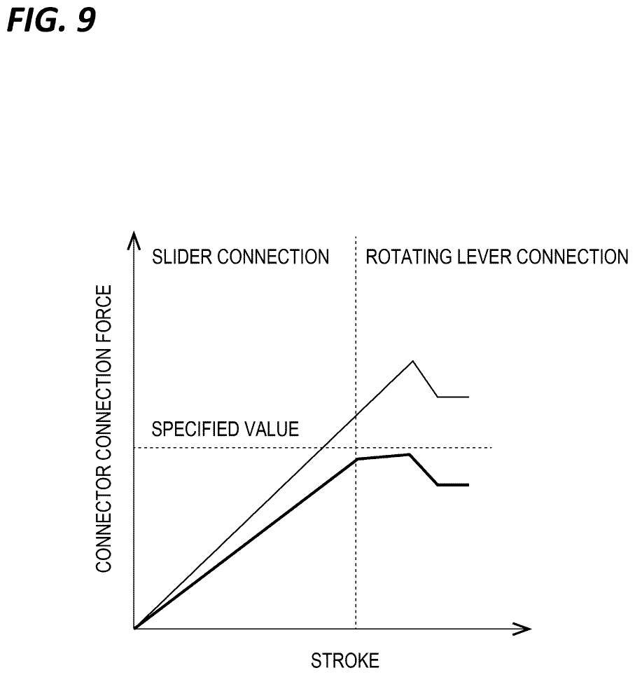

FIG. 9 is a schematic graph showing a change of a connector connection force at the time of connecting the low connection force connector 1 of this embodiment and, in the graph, a left upper line represents a change of a conventional connector connection force when the slide lever 30 is not used and a right lower line represents a change of a connector connection force when the slide lever 30 is used. As shown in FIG. 9, in this embodiment, the connector connection force is lower than before in a sliding movement of changing the position of the slide lever 30 from the initial position to the slide position. Further, in a rotational movement of rotating the slide lever 30 from the slide position to the connection completion position, the connector connection force is even more reduced than before. That is, it is read that the connector connection force is largely different as compared to the conventional configuration not using the slide lever 30.

Next, functions and effects of this embodiment configured as described above are described. The low connection force connector 1 of this embodiment includes the first housing 10 provided with the receptacle 12, the second housing 20 to be fit into the receptacle 12 and the slide lever 30 assembled with the second housing 20 slidably and rotatably. The slide lever 30 includes the cam grooves 33 engageable with the first cam pins 13 provided in the receptacle 12 and the slide holes 34 for slidably receiving the second cam pins 21 provided on the second housing 20, and is displaceable with respect to the second housing 20 between the initial position located when the connection of the both housings 10, 20 is started, the connection completion position located when the connection of the both housings 10, 20 is completed and the slide position located between the initial position and the connection completion position. The slide hole 34 extends in the direction orthogonal to the connection direction of the both housings 10, 20 with the slide lever 30 set at the initial position. In a connection initial stage of the both housings 10, 20, according to a sliding operation of sliding the slide lever 30 with respect to the second housing 20 so that the second cam pins 21 move along the slide holes 34 in the direction orthogonal to the connection direction with the first cam pins 13 introduced in the cam grooves 33 of the slide lever 30 at the initial position, the connection of the both housings 10, 20 is advanced by the cam action between the cam grooves 33 and the first cam pins 13. According to a rotating operation of rotating the slide lever 30 set at the slide position by the sliding operation to the connection completion position about the first cam pins 13 disposed in the cam grooves 33, the second cam pins 21 are pressed in the connection direction by the slide holes 34 and the both housings 10, 20 are connected.

According to the above configuration, in a connection initial stage where a load (connection force) required to connect the both housings 10, 20 can be relatively small, the connection of the both housings 10, 20 can be advanced by the cam action by the sliding operation of the slide lever 30. Further, in the connection final stage where a relatively large load (connection force) is required to set the both housings 10, 20 at the connection completion position, the connection of the both housings 10, 20 can be completed, using the principle of leverage, by the rotating operation of rotating the slide lever 30. By performing the operation of connecting the both housings 10, 20 by a combination of the sliding operation and the rotating operation in this way, an angle of rotation of the slide lever 30 can be made smaller than in the case where the sliding operation is not performed. As a result, the slide lever 30 is not placed on the back surface side of the second housing 20, and a load (connector connection force) required for the connecting operation can be sufficiently reduced while a space for the connecting operation is reduced more than before. Moreover, since such operations in two stages can be performed by one slide lever 30, a simple configuration can be realized without increasing the number of components.

Further, the slide lever 30 is set not to protrude from the first housing 10 in an intersecting direction intersecting the connection direction in a state disposed at the connection completion position.

If the slide lever 30 protrudes from the first housing 10 in the intersecting direction when the connection is completed, the slide lever 30 is easily caught by another component or the like. If a load is applied to the slide lever 30 to rotate the slide lever 30 in a direction opposite to the connection direction, the connected state may be released. According to the above configuration, since the slide lever 30 is hardly caught by another component or the like in the connected state, it can be suppressed that the connected state of the both housings 10, 20 is unintentionally released. Further, in the connected state, the both housings 10, 20 can be made compact.

Further, the slide hole 34 is in the form of a long hole extending in the direction orthogonal to the connection direction with the slide lever 30 set at the initial position. According to this configuration, when being slid, the second cam pins 21 are hardly detached from the slide holes 34. That is, the second cam pins 21 can be stably slid with respect to the slide holes 34 (second housing 20) and, consequently, the both housings 10, 20 can be smoothly connected.

Further, the slide hole 34 extends in a direction oblique to the direction orthogonal to the connection direction with the side of the first cam pins 13 disposed on an opposite side in the connection direction with the slide lever 30 set at the connection completion position.

### OTHER EMBODIMENTS

The present disclosure is not limited to the described and illustrated embodiment. For example, the following embodiments are also included in the technical scope.

(1) Although the slide lever 30 does not protrude in the intersecting direction from the first housing 10 with the slide lever 30 disposed at the connection completion position (state of FIG. 8), a form in which a slide lever projects from a first housing is also included in the technical scope.

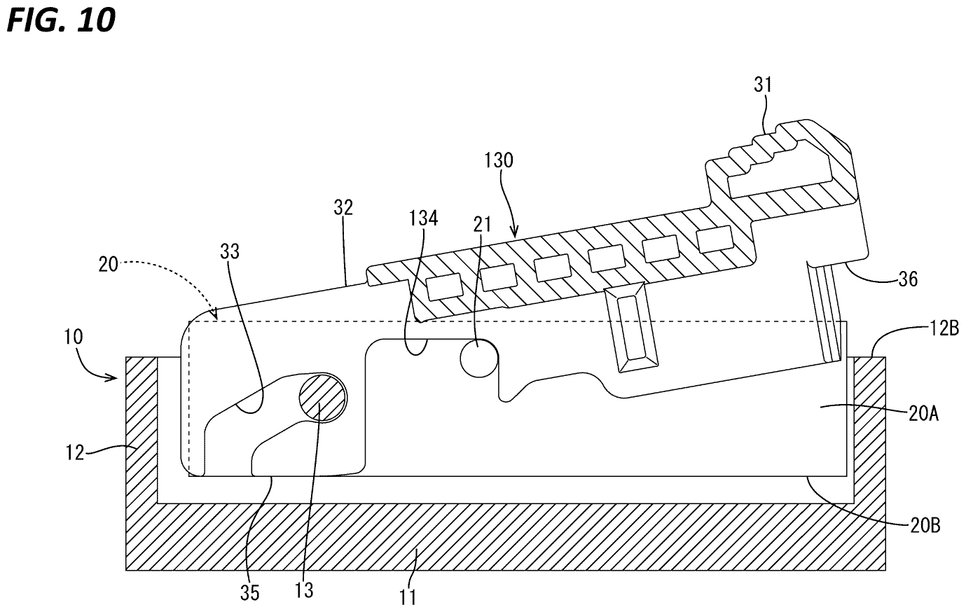

(2) Although the slide guiding portion is shown in the form of a long hole (slide hole 34) in the above embodiment, the slide guiding portion is not limited to the long hole, but may be an edge part 134, in which a second cam pin 21 is slidable in the direction orthogonal to the connection direction and which is cut into a recess capable of pressing the second cam pin 21 in the connection direction when a slide lever 130 is rotated, for example, as shown in FIG. 10.

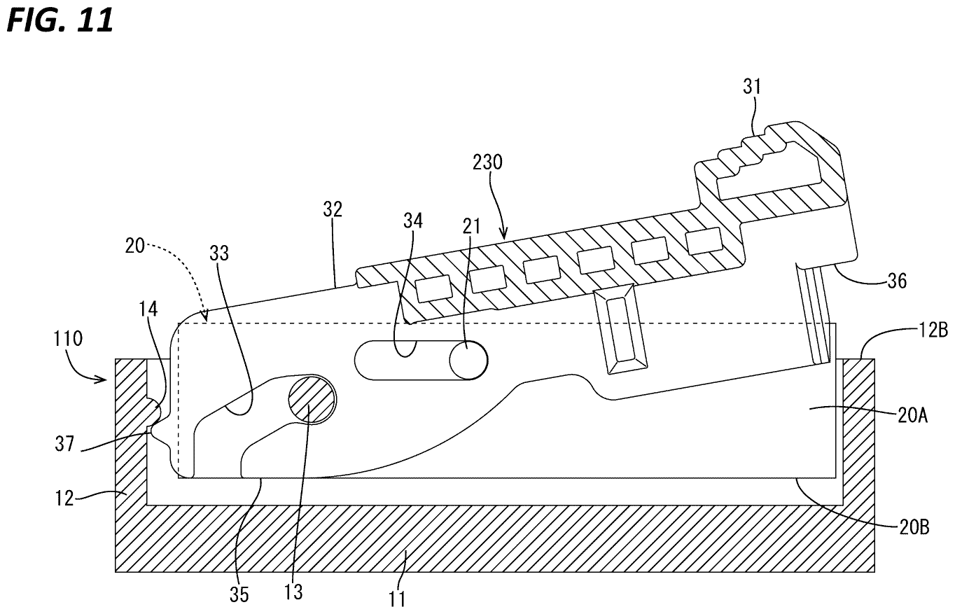

(3) Further, for example, as shown in FIG. 11, a slide lever 230 may include a locking portion 37 projecting in an extension direction of a slide hole 34 on the outer periphery of the left end of an arm portion 32. In the case of such a configuration, by providing a locked portion 14 lockable to the locking portion 37 as the slide lever 230 is slid from an initial position to a slide position in a receptacle 12 of a first housing 110, both housings can be more easily connected, utilizing the pressing of pressing the locked portion 14 by the locking portion 37 according to a rotating operation of the slide lever 230.

(4) The slide lever may be so configured that the left end does not project from the second housing in the connected state.

(5) Although the initial posture guiding portion 35 for guiding the slide lever 30 to the inclined posture at the initial position is provided on the lower edge part of the arm portion 32 in the above embodiment, a configuration capable of guiding the posture of the slide lever may be provided besides the initial posture guiding portions 35.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A low connection force connector, comprising:
a first housing including a receptacle;
a second housing to be fit into the receptacle; and
a slide lever assembled with the second housing slidably and rotatably,
the slide lever including a cam groove engageable with a first cam pin provided in the receptacle and a slide guiding portion for slidably receiving a second cam pin provided on the second housing,
the slide lever being displaceable with respect to the second housing between an initial position located when connection of the both housings is started, a connection completion position located when the connection of the both housings is completed and a slide position located between the initial position and the connection completion position,
the slide guiding portion extending in an intersecting direction intersecting a connection direction of the both housings with the slide lever set at the initial position,
the connection of the both housings being advanced by a cam action between the cam groove and the first cam pin according to a sliding operation of sliding the slide lever with respect to the second housing so that the second cam pin is moved in the intersecting direction by the slide guiding portion with the first cam pin introduced in the cam groove of the slide lever at the initial position in a connection initial stage of the both housings, and
the second cam pin being pressed in the connection direction by the slide guiding portion to connect the both housings according to a rotating operation of rotating the slide lever set at the slide position by the sliding operation to the connection completion position about the first cam pin disposed in the cam groove.

2. The low connection force connector of claim 1, wherein the slide lever is set not to protrude in the intersecting direction from the first housing in a state disposed at the connection completion position.

3. The low connection force connector of claim 1, wherein the slide guiding portion is in the form of a long hole extending in the intersecting direction.

4. The low connection force connector of claim 1, wherein the slide guiding portion extends in an orthogonal direction orthogonal to the connection direction of the both housings with the slide lever set at the initial position and extends in a direction oblique to the orthogonal direction with the first cam pin side disposed on an opposite side in the connection direction with the slide lever set at the connection completion position.

5. The low connection force connector of claim 1, wherein:
the slide lever includes a plate-like arm portion having the cam groove and the slide guiding portion and a locking portion projecting in an extension direction of the slide guiding portion is provided on an outer periphery of the arm portion,
the receptacle is provided with a locked portion lockable to the locking portion as the slide lever is slid from the initial position to the slide position, and
the locking portion presses the locked portion according to the rotating operation of the slide lever, whereby the connection of the both housings progresses.
